(19) United States
(12) Patent Application Publication
(10) Pub. No.: US 2024/0217036 A1
(43) Pub. Date: Jul. 4, 2024

(54) BRAZING SHEETS, ARTICLES FORMED FROM BRAZING SHEETS, AND METHODS OF FORMING ARTICLES

(71) Applicant: ARCONIC TECHNOLOGIES LLC, Pittsburgh, PA (US)

(72) Inventors: Kate J. BEITTENMILLER, Pittsburgh, PA (US); Harry R. ZONKER, Oakmont, PA (US); Baolute REN, Lititz, PA (US)

(21) Appl. No.: 18/557,789

(22) PCT Filed: Apr. 20, 2022
(86) PCT No.: PCT/US2022/071814

§ 371 Date: Oct. 27, 2023

Related U.S. Application Data
(60) Provisional application No. 63/191,362, filed on May 21, 2021.

(51) Int. Cl. B23K 35/02; B23K 35/28; B23K 101/14; B23K 103/10; C22C 21/02; C22C 21/10; F28F 19/06

(52) U.S. Cl. CPC B23K 35/0238; B23K 35/288; C22C 21/02; C22C 21/10; F28F 19/06; B23K 2101/14; B23K 2103/10; F28F 2275/04

(57) ABSTRACT

Brazing sheets, articles formed from or including brazing sheets, and methods of forming articles are provided. The brazing sheet comprises a substrate layer, an interliner layer disposed on the substrate layer, and a brazing layer disposed on the interliner layer. The substrate layer and the brazing layer comprise aluminum alloys. The interliner layer acts as a sacrificial anode and the substrate layer acts as a cathode of a galvanic circuit within the brazing sheet.

### FIELD OF USE

The present disclosure relates to brazing sheets, articles formed from or including brazing sheets, and methods of forming articles.

### BACKGROUND

Heat exchangers may be formed from stacked specially-designed metal plates. These plate-type heat exchangers function by circulating two fluids on opposite sides of a plate, allowing heat exchange between the fluids. To ensure that plate-type heat exchangers have acceptable corrosion resistance, the apparatus may be designed to resist corrosion attack along the joints between plates and through the thickness of the sheet material used to form the plates. Increasing the resistance to corrosion attack in plate-type heat exchangers can present significant challenges.

### SUMMARY

One non-limiting aspect according to the present disclosure is directed to a brazing sheet comprising: a substrate layer; an interliner layer disposed on the substrate layer; and a brazing layer disposed on the interliner layer. The substrate layer comprises an aluminum alloy, and the brazing layer comprises a 4XXX series aluminum alloy. The interliner layer comprises an aluminum alloy comprising, in weight percentages based on total weight of the interliner layer, 0.05 to 1.0 magnesium, 0.5 to 5.0 zinc, aluminum, optionally incidental elements, and impurities. The interliner layer acts as a sacrificial anode and the substrate layer acts as a cathode of a galvanic circuit within the brazing sheet.

In a further non-limiting aspect according to the present disclosure, the interliner layer of the brazing sheet comprises, in weight percentages based on total weight of the interliner layer, 1.5 to 3.0 zinc, 2.0 to 5.0 zinc, or greater than 2.0 to 5.0 zinc. In certain non-limiting embodiments, a sum of the weight percentage concentrations of zinc and magnesium in the interliner layer is 2.0 to 6.0. In various non-limiting embodiments, the interliner layer comprises an aluminum alloy comprising, in weight percentages based on total weight of the interliner layer: 0.1 to 1 silicon; 0 to 0.10 copper; 0 to 0.5 zirconium; 0 to 0.8 iron; 0 to 0.5 manganese; 2.0 to 5.0 zinc; 0.05 to 1 magnesium; 0 to 0.3 titanium; 0 to 0.05 chromium; aluminum; optionally incidental elements; and impurities. In certain non-limiting embodiments, the interliner layer acts as a sacrificial anode of the galvanic circuit relative to the substrate layer and the brazing layer. In various non-limiting embodiments, the substrate layer, the interliner layer, and the brazing layer are bonded together. In certain non-limiting embodiments, the substrate layer of the brazing sheet comprises a 1XXX series aluminum alloy, a 3XXX series aluminum alloy, or a 6XXX series aluminum alloy. For example, the substrate layer can comprise an aluminum alloy comprising, in weight percentages based on total weight of the substrate layer: 0.1 to 1.0 silicon; 0 to 1.0 iron; 0 to 1.2 copper; 0.8 to 1.8 manganese; 0.05 to 1.2 magnesium; 0 to 0.10 chromium; 0 to 0.10 zinc; aluminum; optionally incidental elements; and impurities; and wherein a sum of the weight percentage concentrations of titanium and zirconium is 0.10 to 0.30. In various non-limiting embodiments, the substrate layer is homogenized. In certain non-limiting embodiments, the brazing sheet is suitable for at least one of controlled atmospheric brazing and vacuum brazing. In various non-limiting embodiments, the brazing layer comprises an aluminum alloy comprising, in weight percentages based on total weight of the brazing layer: 5.0 to 15.0 silicon; 0 to 2.5 magnesium; 0 to 1.0 iron; 0 to 1.5 zinc; 0 to 0.5 copper; 0 to 2.0 molybdenum; 0 to 0.3 manganese; 0 to 0.2 titanium; 0 to 0.4 bismuth; 0 to 0.01 chromium; aluminum; optionally incidental elements; and impurities.

A further non-limiting aspect according to the present disclosure is directed to a brazing sheet comprising: a substrate layer; an interliner layer disposed on the substrate layer; a first brazing layer disposed on the interliner layer and a first side of the substrate layer; and a second brazing layer disposed on a second side of the substrate layer, opposite the first side of the substrate layer. The substrate layer comprises an aluminum alloy, the first brazing layer comprises a 4XXX series aluminum alloy, and the second brazing layer comprises a 4XXX series aluminum alloy. The interliner layer comprises an aluminum alloy comprising, in weight percentages based on total weight of the interliner layer: 0.05 to 1.0 magnesium; 0.5 to 5.0 zinc; aluminum; optionally incidental elements; and impurities. The interliner layer acts as a sacrificial anode, and the substrate layer acts as a cathode of a galvanic circuit within the brazing sheet. In various non-limiting embodiments, the brazing sheet consists of the first brazing layer, the second brazing layer, the substrate layer, and the interliner layer. In certain non-limiting embodiments, the interliner layer comprises a thickness that is 8% to 30% of the total thickness of the brazing sheet or a thickness that is 15% to 30% of the total thickness of the brazing sheet.

An additional non-limiting aspect according to the present disclosure is directed to a heat exchanger comprising a structural element comprising all or a portion of a brazing sheet according to the present disclosure. In various non-limiting embodiments, the first brazing layer of the brazing sheet is in contact with a fluid pathway in the heat exchanger. In certain non-limiting embodiments, the heat exchanger does not fail when subjected to at least 600 hours of continuous flow with Oyama River water solution.

Yet a further non-limiting aspect according to the present disclosure is directed to a method for forming an article. The method comprises contacting a first part comprising a first material with a second part comprising all or a portion of a brazing sheet according to the present disclosure. The method further comprises coupling the first part to the second part by a process comprising at least one of controlled atmospheric brazing and vacuum brazing. In various non-limiting embodiments of the method, the first material comprises aluminum or an aluminum alloy. In certain non-limiting embodiments of the method, the article is a heat exchanger.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawing, wherein:

FIG. 1 is a schematic side elevational view of a non-limiting embodiment of a brazing sheet according to the present disclosure;

FIG. 2 is a schematic side elevational view of an alternative non-limiting embodiment of a brazing sheet according to the present disclosure; and

FIG. 3 is a block diagram of a non-limiting embodiment of a method according to the present disclosure for forming articles from brazing sheets.

The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other non-limiting embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the example is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

Various non-limiting embodiments of alloys according to the present disclosure optionally include intentional additions of incidental elements that may, for example, aid in production of the alloy and/or improve one or more properties or characteristics of the alloy. For example, certain non-limiting embodiments of alloys according to the present disclosure may include intentional incidental additions of one or more of grain refining elements, and one or more deoxidizing elements. In various non-limiting embodiments, the total concentration of incidental elements in alloys according to the present disclosure preferably does not exceed 1 weight percent based on the total weight of the alloy, and the concentration of any single incidental element preferably does not exceed 0.2 weight percent based on the total weight of the alloy. For example, bismuth may be added to the alloys of the present disclosure in a range of 0 to 0.2 weight percent to aid in the braze metal melt flow.

Various non-limiting embodiments of alloys according to the present disclosure may include impurities. As used herein, “impurities” are materials that may be present in relatively minor concentrations in alloys according to the present disclosure but that are not intentionally added to affect properties or characteristics of the alloy. For example, impurities in the alloys according to the present disclosure may be present in minor concentrations due to, for example, unavoidable or unintentional presence in feed materials, incorporation from the atmosphere during melting and refining, contamination by contact with processing equipment. In various non-limiting embodiments, the total concentration of impurities in alloys according to the present disclosure preferably does not exceed 0.15 weight percent based on the total weight of the alloy, and the concentration of any single impurity preferably does not exceed 0.05 weight percent based on the total weight of the alloy.

Brazed joints can be susceptible to galvanic corrosion due to a galvanic difference between the composition of the substrate layer and the composition of a material that is coupled to (e.g., galvanically coupled to) the substrate layer (e.g., the brazing layer or the interliner layer). As used herein, “galvanic difference” means aa corrosion potential difference between one region (e.g., layer) and another region. Corrosion potential can be measured according to ASTM G69-20 (May 2020). The corrosion potential difference between the regions can be due to a difference in the compositions of the regions. Without being bound to a particular mechanism or theory, in some non-limiting embodiments according to the present disclosure, when two regions having a corrosion potential difference are coupled together and are in the presence of an electrolyte, one region will act as the anode of a galvanic circuit, while the other region will act as the cathode of the galvanic circuit. As used herein, “anode” or “anodic” refers to a region having a composition that is more electronegative than another region. As used herein, “cathode” or “cathodic” refers to a region having a composition that is less electronegative than another region.

Heat exchangers are often designed using stacked plates that are coupled together utilizing a brazing process. The process results in the creation of a small gap between plates, allowing two fluids (e.g., an oil and a coolant) to circulate on opposite sides of a plate to produce the desired cooling. To improve the corrosion resistance of brazed joints and thereby increase the operational life of articles comprising the brazed joints, such as heat exchangers, the present disclosure provides a brazing sheet comprising a substrate layer and a brazing layer disposed on the substrate layer wherein the interliner layer acts as a sacrificial anode and the substrate layer acts as a cathode of a galvanic circuit within the brazing sheet. In this way, corrosion attack is directed to the interliner layer of the brazing sheet. In various non-limiting embodiments, the thickness of the interliner layer can be increased relative to a typical interliner layer to accommodate the increased corrosion rate as a result of the anode configuration. Thus, non-limiting embodiments of brazing sheets provided herein can provide enhanced corrosion performance and increased operational life of articles made from or incorporating the brazing sheets.

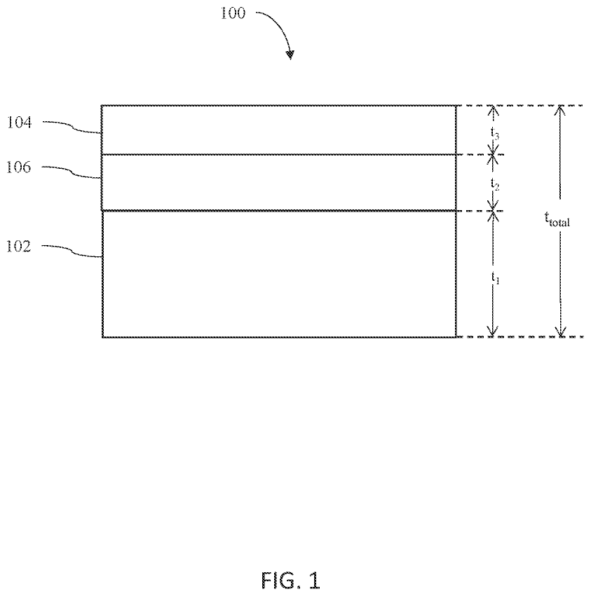

Referring to FIG. 1, one non-limiting embodiment of a brazing sheet 100 according to the present disclosure is provided. The brazing sheet 100 comprises a substrate layer 102, a brazing layer 104 disposed on the substrate layer 102, and an interliner layer 106 disposed intermediate the substrate layer 102 and the brazing layer 104. In various non-limiting embodiments, the substrate layer 102, the interliner layer 106, and the brazing layer 104 are bonded together. The brazing sheet 100 can have a composition and thickness suitable for use in at least one of controlled atmospheric brazing and vacuum brazing.

To enhance the corrosion resistance of the substrate layer 102, the interliner layer 106 is configured to act as a sacrificial anode and the substrate layer 102 is configured to act as a cathode of a galvanic circuit within the brazing sheet 100. For example, the composition of the interliner layer 106 can be more anodic than a composition of the substrate layer 106. In various non-limiting embodiments, a corrosion potential difference between the interliner layer 106 and the substrate layer 102 can be at least 1 mV as measured according to ASTM G69-20, such as, for example, at least 2 mV, at least 5 mV, at least 10 mV, at least 15 mV, at least 20 mV, at least 30 mV, at least 40 mV, at least 50 mV, at least 60 mV, at least 70 mV, at least 80 mV, at least 90 mV, at least 100 mV, at least 120 mV, at least 130 mV, at least 140 mV, or at least 150 mV, all as measured according to ASTM G69-20. In various non-limiting embodiments, a corrosion potential difference between the interliner layer 106 and the substrate layer 102 can be no greater than 1000 mV as measured according to ASTM G69-20, such as, for example, no greater than 500 mV, no greater than 250 mV, no greater than 150 mV, or no greater than 100 mV. In various non-limiting embodiments, a corrosion potential difference between the interliner layer 106 and the substrate layer 102 can be in a range of 1 mV to 1000 mV, such as, for example 5 mV to 500 mV, 10 mV to 250 mV, or 50 mV to 500 mV, all as measured according to ASTM G69-20.

In various non-limiting embodiments, the interliner layer 106 can be configured to act as a sacrificial anode of the galvanic circuit relative to the substrate layer 102 and the brazing layer 104. For example, the composition of the interliner layer 106 can be more anodic than a composition of the brazing layer 104 and more anodic than a composition of the substrate layer 102. In various non-limiting embodiments, regardless of the number of layers in the brazing sheet 100, a gradient of galvanic potential can be configured within the brazing sheet 100 in which the interliner layer 106 is the most anodic of the layers and the substrate layer 102 is the most cathodic of the layers.

In order to suitably configure the galvanic circuit within the brazing sheet 100 so that the interliner layer 106 acts as a sacrificial anode, the interliner layer 106 is configured with a composition that has a more negative corrosion potential than a composition of the substrate layer 102 and, in various non-limiting embodiments, has a more negative corrosion potential than a composition of the brazing layer 104. For example, the interliner layer 106 can comprise zinc (Zn), which can create a more electronegative corrosion potential of the interliner layer 106. In certain non-limiting embodiments, the interliner layer comprises, in weight percentages based on total weight of the interliner layer 106, at least 0.5 zinc, at least 1.0 zinc, at least 1.5 zinc, at least 1.75 zinc, at least 2.0 zinc, greater than 2.0 zinc, at least 2.1 zinc, at least 2.2 zinc, or at least 2.3 zinc. In various non-limiting embodiments, the interliner layer 106 can comprise, in weight percentages based on total weight of the interliner layer 106, no greater than 5.0 zinc, or no greater than 4.5 zinc. For example, the interliner layer 106 can comprise, in weight percentages based on total weight of the interliner layer, 0.5 to 5 zinc, or 2.0 to 5.0 zinc. Zinc can perform a variety of functions, such as, for example, directing corrosion to the interliner layer 106 as a result of the galvanic circuit and increasing the corrosion and erosion resistance of the interliner layer 106 to corrosion resulting from the galvanic circuit.

Additionally, the interliner layer 106 can comprise magnesium (Mg) to create a more electronegative corrosion potential of the interliner layer 106 and thereby enhance corrosion properties of the brazing sheet 100. In various non-limiting embodiments, the magnesium can enhance the erosion resistance of the brazing sheet 100. For example, the interliner layer 106 can comprise 0.05 to 1.0 weight percent magnesium to facilitate vacuum brazing with the brazing sheet 100, such as, for example, 0.35 to 1.0 magnesium or 0.45 to 1.0 magnesium. In various non-limiting embodiments, the interliner layer 106 can comprise 0.05 to 0.45 weight percent magnesium to facilitate controlled atmospheric brazing with the brazing sheet 100.

Without being bound to any particular theory, the inventors believe that including both zinc and magnesium in the interliner layer 106 results in a synergistic improvement in corrosion protection and erosion protection of the interliner layer 106. This, in turn, can increase the overall corrosion resistance and erosion resistance of the brazing sheet 100 because the corrosion of the brazing sheet 100 is substantially directed to the interliner layer 106 as a result of the galvanic circuit established in the brazing sheet 100. In various non-limiting embodiments, a sum of the weight percentage concentrations of zinc and magnesium in the interliner layer can be in a range of 2.0 to 6.0. Balancing the zinc and magnesium levels in the interliner layer can facilitate various brazing processes. For example, to facilitate vacuum brazing it may be desirable to provide lower levels of zinc (e.g., due to zinc evaporation) and higher levels of magnesium (e.g., to inhibit aluminum oxide formation), while lower levels of magnesium may be desirable to facilitate controlled atmospheric brazing.

In various non-limiting embodiments, the interliner layer 106 of the brazing sheet 100 can comprise an aluminum alloy, such as, for example, an aluminum alloy comprising, in weight percentages based on total weight of the aluminum alloy: 0.1 to 1.0 magnesium; 0.5 to 5 zinc; aluminum; optionally incidental elements; and impurities. In various non-limiting embodiments, the interliner layer 106 can comprise an aluminum alloy comprising, in weight percentages based on the total weight of the aluminum alloy: 0.1 to 1.0 silicon; 0 to 0.10 copper; 0 to 0.5 zirconium; 0 to 0.8 iron; 0 to 0.5 manganese; 2.0 to 5.0 zinc; 0.1 to 1.0 magnesium; 0 to 0.3 titanium; 0 to 0.05 chromium; aluminum; optionally incidental elements; and impurities. In certain non-limiting embodiments, the interliner layer 106 can comprise an aluminum alloy comprising, in weight percentages based on the total weight of the aluminum alloy: 0.1 to 1.0 silicon; 0 to 0.05 copper; 0 to 0.5 zirconium; 0 to 0.8 iron; 0 to 0.5 manganese; 2.0 to 5.0 zinc; 0.1 to 1.0 magnesium; 0 to 0.3 titanium; 0 to 0.05 chromium; aluminum; optionally incidental elements; and impurities.

Again referring to FIG. 1, the substrate layer 102 of the brazing sheet 100 comprises an aluminum alloy, such as, for example, a 1XXX series aluminum alloy, a 3XXX series aluminum alloy, or a 6XXX series aluminum alloy. In various non-limiting embodiments, the substrate layer 102 comprises an aluminum alloy comprising, in weight percentages based on total weight of the alloy: 0.1 to 1.0 silicon; 0 to 1.0 iron; 0 to 1.2 copper; 0.8 to 1.9 manganese; 0.05 to 1.2 magnesium; 0 to 0.10 chromium; 0 to 0.10 zinc; aluminum; optionally incidental elements; and impurities; and wherein a sum of the weight percentages of titanium and zinc is 0.10 to 0.30. In various non-limiting embodiments, the substrate layer 102 comprises an aluminum alloy comprising, in weight percentages based on total weight of the alloy: 0.1 to 1.0 silicon; 0 to 1.0 iron; 0.1 to 1.0 copper; 0.8 to 1.8 manganese; 0.05 to 1.2 magnesium; 0 to 0.10 chromium; 0 to 0.10 zinc; aluminum; optionally incidental elements; and impurities; and wherein a sum of the weight percentages of titanium and zinc is 0.10 to 0.20. In various non-limiting embodiments, the substrate layer 102 can be processed by a hot thermal treatment, e.g., a homogenization process (e.g., a heat treatment between 900 degrees Fahrenheit to 1150 degrees Fahrenheit or 1000 degrees Fahrenheit to 1140 degrees Fahrenheit), so that the substrate layer 102 exhibits favorable formability. For example, in a non-limiting embodiment the substrate layer is processed using the homogenization process described in U.S. Pat. No. 7,255,932, the entire disclosure of which is hereby incorporated herein by reference.

Referring to FIG. 1, the brazing layer 104 of brazing sheet 100 comprises an aluminum alloy, such as, for example, a 4XXX series aluminum alloy. In various non-limiting embodiments, the brazing layer 104 comprises an aluminum alloy comprising, in weight percentages based on total weight of the alloy: 5 to 15.0 silicon; 0 to 2.5 magnesium; 0 to 1.0 iron; 0 to 1.5 zinc; 0 to 0.5 copper; 0 to 2.0 molybdenum; 0 to 0.3 manganese; 0 to 0.2 titanium; 0 to 0.4 bismuth; 0 to 0.01 chromium; aluminum; optionally incidental elements; and impurities.

The thickness of each layer in brazing sheet 100 can be configured based on the desired structural properties of the article to be produced from or incorporating the brazing sheet 100. For example, in various non-limiting embodiments, the substrate layer 102 can comprise a first thickness, t₁, that can be in a range of 50% to 85% of a total thickness, i.e., tₜₒₜₐₗ, of the brazing sheet 100.

Since the interliner layer 106 can be configured as the sacrificial anode of the brazing sheet 100, it will likely corrode and/or erode before other layers of the brazing sheet 100. Thus, increasing the thickness of the interliner layer 106 can improve the resistance of an article formed by the brazing sheet 100 to failure due to corrosion and/or erosion. In various non-limiting embodiments, the interliner layer 106 can comprise a second thickness, t₂, that is at least 8% of the total thickness (tₜₒₜₐₗ) of the brazing sheet 100, such as, for example, at least 10%, at least 12%, at least 15%, at least 18%, at least 20%, or at least 25% of the total thickness (tₜₒₜₐₗ) of the brazing sheet 100. For example, in various non-limiting embodiments the interliner layer 106 can comprise a second thickness, t₂, that is in a range of 8% to 30%, 8% to 18%, 12% to 30%, 12% to 18%, 15% to 25%, 15% to 30%, 18% to 30%, or 20% to 30% of the total thickness (tₜₒₜₐₗ) of the brazing sheet 100.

In various non-limiting embodiments, the brazing layer 104 can comprise a third thickness, t₃, that is in a range of 3% to 20% of the total thickness (tₜₒₜₐₗ) of the brazing sheet 100. In various non-limiting embodiments, the first thickness, t₁, is greater than the second thickness, t₂, and also is greater than the third thickness, t₃. In certain non-limiting embodiments, the total thickness (tₜₒₜₐₗ) of the brazing sheet 100 is in a range of 100 μm to 5 mm, such as, for example, in a range of 200 μm to 1 mm.

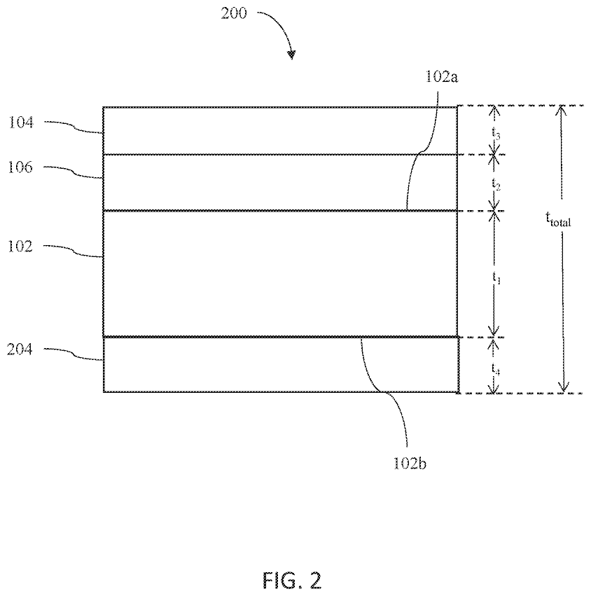

In various non-limiting embodiments, a brazing sheet according to the present disclosure may comprise one or more layers in addition to a substrate layer, an interliner layer, and a brazing layer. For example, referring to the non-limiting embodiment shown schematically in FIG. 2, brazing sheet 200 comprises substrate layer 102, interliner layer 106, first brazing layer 104, and second brazing layer 204. In various non-limiting embodiments, the substrate layer 102, the interliner layer 106, the first brazing layer 104, and the second brazing layer 204 are bonded together to form the brazing sheet 200. The brazing sheet 200 can be suitable for use in at least one of controlled atmospheric brazing and vacuum brazing. For example, the brazing sheet 200 can comprise layers having compositions that make the brazing sheet 200 suitable for use in controlled atmospheric brazing and/or vacuum brazing. Using a single interliner layer 106 configured as a sacrificial anode in the brazing sheet 200 and providing a thickness of the interliner layer 106 that will sufficiently accommodate corrosive attack, which can improve the overall corrosion and erosion performance of the brazing sheet 100. In various non-limiting embodiments, the brazing sheet 200 can comprise a second interliner layer (not shown), which may or may not also be configured as a sacrificial anode relative to the substrate layer 102.

As shown in FIG. 2, the second brazing layer 204 is disposed on a second side 102b of substrate layer 102 and the first brazing layer 104 is disposed on a first side 102a of substrate layer 102. The second side 102b of the substrate layer 102 is disposed opposite the first side 102a of the substrate layer 102. In various embodiments, the second brazing layer 204 can be configured with a composition as described herein with respect to the first brazing layer 104. In various non-limiting embodiments, a composition of the second brazing layer 204 can be the same as or different from a composition of the first brazing layer 104.

A thickness of each layer in the brazing sheet 200 can be configured based on the desired structural properties of the article to be produced from or incorporate all or a portion of the brazing sheet 200. For example, in various non-limiting embodiments the substrate layer 102 can comprise a first thickness, t₁, that can be in a range of 50% to 85% of a total thickness, i.e., tₜₒₜₐₗ, of the brazing sheet 100. In various non-limiting embodiments the interliner layer 106 can comprise a second thickness, t₂, that is at least 8% of the of a total thickness (tₜₒₜₐₗ) of the brazing sheet 100, such as, for example, at least 10%, at least 12%, at least 15%, at least 18%, at least 20%, or at least 25% of the total thickness (tₜₒₜₐₗ) of the brazing sheet 100. For example, the interliner layer 106 can comprise a second thickness, t₂, that is in a range of 8% to 30%, 8% to 18%, 12% to 30%, 12% to 18%, 15% to 25%, 15% to 30%, 18% to 30%, or 20% to 30% of the total thickness (tₜₒₜₐₗ) of the brazing sheet 100. In various non-limiting embodiments the first brazing layer 104 and the second brazing layer 204 can comprise a combined thickness, t₃+t₄, that is in a range of 3% to 20% of the total thickness (tₜₒₜₐₗ) of the brazing sheet 200. In certain non-limiting embodiments, the total thickness (tₜₒₜₐₗ) of the brazing sheet 200 is in a range of 100 μm to 5 mm, such as, for example, in a range of 200 μm to 1 mm.

In various non-limiting embodiments, an article such as, for example, a heat exchanger, can comprise a structural element comprising all or a portion of brazing sheet according to the present disclosure. In various non-limiting embodiments, a heat exchanger or other article can comprise a structural element comprising all or a portion of brazing sheet 100 and/or all or a portion of brazing sheet 200. The heat exchanger can be, for example, an oil cooler or a radiator. The brazing layer 104 can be in contact with a fluid pathway in the heat exchanger. For example, the brazing layer 104 can be in contact with a coolant during operation of the heat exchanger. In various non-limiting embodiments, a heat exchanger comprising a structural element comprising all or a portion of brazing sheet according to the present disclosure does not fail when subjected to at least 600 hours of continuous flow with Oyama River water solution, such as, for example, at least 640 hours, at least 700 hours, or at least 750 hours. As understood to those having ordinary skill, Oyama River water solution comprises 225.50 mg of NaCl, 89 mg of Na₂SO₄, 2.65 mg of CuCl₂*2H₂O, 145 mg of FeCl₃*6H₂O, (thereby having a Cl⁻ of 195 ppm) and balance deionized water and impurities in a total solution volume of 20 liters. The flow rate is dependent upon the size of the heat exchanger. The Oyama River water solution is 95 degrees Celsius and the pH of the Oyama River water solution is 3.2. As the heat exchanger corrodes during the test, the pH of the Oyama River water solution will increase towards a neutral pH (e.g., 7). The heat exchanger is evaluated at various time intervals during the test procedure to determine if there is a perforation (e.g., the solution reached the other side of the material) in the heat exchanger, at which point it is considered that the heat exchanger has failed.

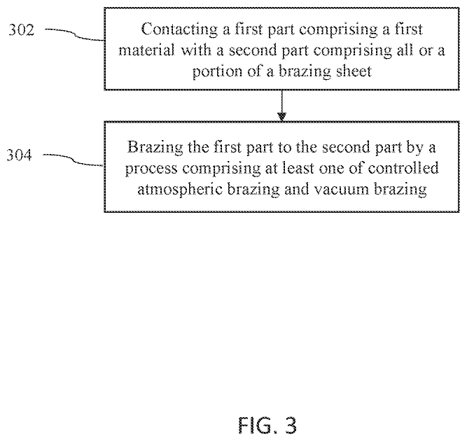

FIG. 3 provides a block diagram of a non-limiting embodiment of a method according to the present disclosure for forming an article such as, for example, a heat exchanger. The method comprises contacting a first part comprising a first material with a second part comprising all or a portion of an embodiment of a brazing sheet according to the present disclosure. For example, a non-limiting embodiment of a method according to the present disclosure may comprise contacting a first part comprising a first material with a second part comprising all or a portion of brazing sheet 100 and/or brazing sheet 200 (FIG. 3, step 302) as described herein. In various non-limiting embodiments, the first part can be coupled to the second part by a process comprising at least one of controlled atmospheric brazing and vacuum brazing (step 304).

In various non-limiting embodiments, step 304 comprises controlled atmospheric brazing and a flux can be used. In certain non-limiting embodiments, step 304 comprises controlled atmospheric brazing and the substrate layer 102 can comprise an aluminum alloy comprising, in weight percentages based on total weight of the alloy, 0 to 0.45 magnesium. In various non-limiting embodiments, step 304 comprises vacuum brazing and the substrate layer 102 can comprise an aluminum alloy comprising, in weight percentages based on total weight of the alloy, 0.05 to 1.0 magnesium, such as, for example, 0.35 to 1.0 magnesium or 0.45 to 1.0 magnesium. In various non-limiting embodiments, the first material comprises aluminum or an aluminum alloy.

### Examples

### Evaluation 1

Evaluations were conducted to assess the corrosion resistance of a comparative brazing sheet 1 without an interliner (3-layer brazing sheet) and brazing sheets 2-4 according to the present disclosure that include at least one interliner. The composition of various aluminum alloys used in the examples herein is shown in Table 1. The configurations of the comparative brazing sheet 1 and brazing sheets 2-4 are shown in Table 2. The brazing sheets were constructed from a substrate layer; a first brazing layer on a first side of the substrate layer; a second brazing layer on a second side of the substrate layer opposite the first side; optionally, a first interliner layer intermediate the first brazing layer and the substrate layer; and optionally, a second interliner layer intermediate the second brazing layer and the substrate layer. All materials were cold rolled to a final thickness of 0.6 mm and produced in —O temper condition.

The comparative brazing sheet 1 and brazing sheets 2-4 were subject to corrosion resistance testing by continuously flowing of Oyama River water solution between two brazing sheets that are 0.5 inch width by 6 inches long. Where there was a single interliner in the brazing sheet, the single interliner was oriented towards the Oyama River water solution. The brazing sheets were evaluated for perforations at regular intervals during the testing and the results are shown in Table 2. The perforations were counted for each brazing sheet.

TABLE 1

| | | | | | | | | Al and |
|---|---|---|---|---|---|---|---|---|
| Aluminum | | | | | | | | Incidental |
| Alloy | Si | Fe | Cu | Mn | Mg | Zn | Ti | Impurities |
| Alloy A | 0.39 | 0.19 | 0.05 | 0.05 | 0.39 | 2.44 | — | Balance |
| Alloy B | 0.30 | 0.2 | — | — | 1 | 2.94 | — | Balance |
| Alloy C | 0.33 | 0.2 | 0.04 | 0.02 | 0.37 | — | — | Balance |
| Alloy D | 0.06 | 0.21 | 0.45 | 1.1 | 0.22 | — | 0.14 | Balance |
| 4147 | 11-13 | 0.8 | 0.25 | 0.1 | 0.1-0.5 | 0.2 | — | Balance |

TABLE 2

| | | Com- | | | |
|---|---|---|---|---|---|
| | | parative | | | |
| | | Brazing | Brazing | Brazing | Brazing |
| | | Sheet 1 | Sheet 2 | Sheet 3 | Sheet 4 |
| Composition | FBL | 4147 | 4147 | 4147- | 4147 |
| | | | | Series | |
| | FIL | Not Used | Alloy A | Alloy A | Alloy B |
| | SL | Aloy D | Alloy D | Alloy D | Alloy D |
| | SIL | Not Used | Alloy A | Not Used | Not Used |
| | SBL | 4147 | 4147 | 4147 | 4147 |
| Thickness | FBL | 8 | 8 | 8 | 8 |
| | (% of total) | | | | |
| | FIL (% of total) | Not Used | 12 | 18 | 18 |
| | SL (% of total) | 74 | 60 | 66 | 66 |
| | SIL (% of total) | Not Used | 12 | Not Used | Not Used |
| | SBL(% of total) | 8 | 8 | 8 | 8 |
| | Overall (mm) | 0.6 | 0.6 | 0.6 | 0.6 |
| Number of | After 250 hrs | >20 | 0 | 0 | 0 |
| Perforations | After 515 hrs | Not Tested | 0 | 0 | 0 |
| Observed | After 720 hrs | Not Tested | >30 | 1 | 0 |

FBL = First Brazing Layer
FIL = First Interliner Layer
SL = Substrate Layer
SIL = Second Interliner Layer
SBL = Second Brazing Layer

Comparative brazing sheet 1 was observed to have perforations after only 320 hours and testing was discontinued due to the significant leaking observed and lack of corrosion resistance of comparative brazing sheet 1. Brazing sheet 2, which had two interliners comprising Alloy A and a thickness of 12% of the total thickness of brazing sheet 2 was observed to have no perforations after 515 hrs. Perforations in brazing sheet 2 were observed after 720 hrs. Brazing sheet 3, which had a single interliner comprising Alloy A and a thickness of 18% of the total thickness of brazing sheet 3 was observed to have no perforations after 515 hrs. Additionally, even after 720 hours only one small perforation was observed in brazing sheet 3. Brazing sheet 4, which had a single interliner comprising Alloy B and a thickness of 18% of the total thickness of brazing sheet 4 was observed to have no perforations even after 720 hrs.

Protection against the Oyama River water solution may only be needed on one side of the brazing sheet as illustrated by a comparison of Brazing Sheets 1 and 2. By utilizing a single interliner layer in the brazing sheet configured as a sacrificial anode, the interliner layer can be thicker since the total thickness of the brazing sheet can be limited by manufacturing processes and reducing the thickness of the substrate layer can be undesirable. Thus, because corrosion protection can be selectively increased on the side of the brazing sheet that experiences the most corrosion, corrosion performance would further increase.

### Evaluation 2

A first comparative plate-type heat exchangers comprising comparative was prepared from comparative brazing sheets and a second plate-type heat exchanger was prepared from brazing sheets according to the present disclosure for testing with Oyama River water solution. Each heat exchanger was fabricated from brazing sheets comprising the following five layers: a substrate layer; a first brazing layer on a first side of the substrate layer; a second brazing layer on a second side of the substrate layer opposite the first side; a first interliner layer intermediate the first brazing layer and the substrate layer; and a second interliner layer intermediate the second brazing layer and the substrate layer. For each brazing sheet, the first brazing layer was 8% of the total thickness of the brazing sheet, the first interliner layer was 12% of the total thickness of the brazing sheet, the substrate layer was 60% of the total thickness of the brazing sheet, the second interliner layer was 12% of the total thickness of the brazing sheet, and the second brazing layer is 8% of the total thickness of the brazing sheet. Table 3 provides the composition of each layer of the brazing sheets used in the heat exchangers subjected to the corrosion testing.

TABLE 3

| | Overall | | | | | |
|---|---|---|---|---|---|---|
| | Thickness | | | | | |
| | of Brazing | First | First | | Second | Second |
| | Sheet | Brazing | Interliner | Substrate | Interliner | Brazing |
| Heat Exchanger | (mm) | Layer | Layer | Layer | Layer | Layer |
| Comparative | 0.6 | 4147 | Alloy C | Alloy D | Alloy C | 4147 |
| HX 1 | | | | | | |
| Example | 0.6 | 4147 | Alloy A | Alloy D | Alloy A | 4147 |
| HX 2 | | | | | | |

The heat exchanger of Example HX 2 was prepared according to the present disclosure utilizing vacuum brazing from brazing sheet including zinc in the aluminum alloy of the first and second interliner layers, so that those layers acted as sacrificial anodes in the brazing sheet. The heat exchanger of Comparative HX 1 was fabricated from brazing sheet including layers having the same composition as those used in the heat exchanger of Example HX 2 except that the interliner layers of the brazing sheet used in the heat exchanger of Comparative HX 1 did not include zinc. Both heat exchangers were subjected to continuous flow Oyama River water solution testing (e.g., no stagnation). Each heat exchanger was evaluated for failure periodically during the Oyama River water solution testing, and the time failure was detected is noted in Table 4 below.

TABLE 4

| Heat Exchanger | Detected time of Failure (hrs) |
|---|---|
| Comparative HX 1 | 500 |
| Example HX 2 | 640 |

The results in Table 4 show that the addition of zinc to the magnesium-containing aluminum alloy resulted in improved corrosion and/or erosion resistance when evaluated by Oyama River water solution testing. A 5-layer structure as used in Example HX 2 can facilitate manufacturing process, when bonding the layers together in the brazing sheet and when orienting the brazing sheet to create a heat exchanger.

The following numbered clauses are directed to various non-limiting and aspects according to the present disclosure.

1. A brazing sheet comprising:
a substrate layer comprising an aluminum alloy;
an interliner layer disposed on the substrate layer, the interliner layer comprising an aluminum alloy comprising, in weight percentages,
   0.05 to 1.0 magnesium,
   0.5 to 5.0 zinc,
   aluminum,
   optionally incidental elements, and
   impurities; and
a brazing layer comprising a 4XXX series aluminum alloy, the brazing layer disposed on the interliner layer;
provided that the interliner layer acts as a sacrificial anode and the substrate layer acts as a cathode of a galvanic circuit within the brazing sheet.
   2. The brazing sheet of clause 1, wherein the interliner layer comprises, in weight percentages, 1.5 to 3.0 zinc.
   3. The brazing sheet of clause 1, wherein the interliner layer comprises, in weight percentages, 2.0 to 5.0 zinc.
   4. The brazing sheet of clause 1, wherein the interliner layer comprises, in weight percentages, greater than 2.0 to 5.0 zinc.
   5. The brazing sheet of any of clauses 1 to 4, wherein a sum of the weight percentage concentrations of zinc and magnesium in the interliner layer is 2.0 to 6.0.
   6. The brazing sheet of any of clauses 1 to 5, wherein the interliner layer comprises an aluminum alloy comprising, in weight percentages:
0.1 to 1.0 silicon;
0 to 0.10 copper;
0 to 0.5 zirconium;
0 to 0.8 iron;
0 to 0.5 manganese;
2.0 to 5.0 zinc;
0.1 to 1 magnesium;
0 to 0.3 titanium;
0 to 0.05 chromium;
aluminum;
optionally incidental elements; and
impurities.
   7. The brazing sheet of any of clauses 1 to 6, wherein the interliner layer acts as a sacrificial anode of the galvanic circuit relative to the substrate layer and the brazing layer.
   8. The brazing sheet of any of clauses 1 to 7, wherein the substrate layer, the interliner layer, and the brazing layer are bonded together.
   9. The brazing sheet of any of clauses 1 to 8, wherein:
the brazing layer is a first brazing layer disposed on a first side of the substrate layer; and
a second brazing layer is disposed on a second side of the substrate layer, opposite the first side of the substrate layer, the second brazing layer comprising a 4XXX series aluminum alloy.
   10. The brazing sheet of clause 9, wherein:
the interliner layer is a first interliner disposed intermediate the first brazing layer and the first side of the substrate layer; and
a second interliner layer is disposed intermediate the second brazing layer and the second side of the substrate layer.
   11. The brazing sheet of clause 9, wherein the brazing sheet consists of the first brazing layer, the second brazing layer, the substrate layer, and the interliner layer.
   12. The brazing sheet of any of clauses 9 to 11, wherein the interliner layer comprises a thickness that is 8% to 30% of the total thickness of the brazing sheet.
   13. The brazing sheet of any of clauses 9 to 11, wherein the interliner layer comprises a thickness that is 15% to 30% of the total thickness of the brazing sheet.
   14. The brazing sheet of any of clauses 1 to 13, wherein the substrate layer comprises a 1XXX series aluminum alloy, a 3XXX series aluminum alloy, or a 6XXX series aluminum alloy.
   15. The brazing sheet of any of clauses 1 to 14, wherein the brazing sheet is suitable for at least one of controlled atmospheric brazing and vacuum brazing.
   16. The brazing sheet of any of clauses 1 to 15, wherein the brazing layer is an aluminum alloy comprising, in weight percentages:
5 to 15.0 silicon;
0 to 2.5 magnesium;
0 to 1.0 iron;
0 to 1.5 zinc;
0 to 0.5 copper;
0 to 2.0 molybdenum;
0 to 0.3 manganese;
0 to 0.2 titanium;
0 to 0.4 bismuth;
0 to 0.01 chromium;
aluminum;
optionally incidental elements; and
impurities.
   17. The brazing sheet of any of clauses 1 to 16, wherein the substrate layer is an aluminum alloy comprising, in weight percentages:
0.1 to 1.0 silicon;
0 to 1.0 iron;
0 to 1.2 copper;
0.8 to 1.9 manganese;
0.05 to 1.2 magnesium;
0 to 0.10 chromium;
0 to 0.10 zinc;
aluminum;
optionally incidental elements; and
impurities; and
provided that a sum of weight percentages of titanium and zirconium is 0.10 to 0.30.
   18. The brazing sheet of any of clauses 1 to 17, wherein the substrate layer is homogenized.
   19. A heat exchanger comprising a structural element comprising all or a portion of the brazing sheet of any of clauses 1 to 18.
   20. A heat exchanger comprising a structural element comprising all or a portion of the brazing sheet of any of clauses 9 to 13, wherein the first brazing layer is in contact with a fluid pathway in the heat exchanger.
   21. The heat exchanger of any of clauses 19 and 20, wherein the heat exchanger is corrosion resistant when subjected to at least 600 hours of continuous flow of an Oyama River water solution.
   22. A method for forming an article, the method comprising:
contacting a first part comprising a first material with a second part comprising all or a portion of the brazing sheet of any of clauses 1 to 18; and
coupling the first part to the second part by a process comprising at least one of controlled atmospheric brazing and vacuum brazing.
   23. The method of clause 22, wherein the first material comprises aluminum or an aluminum alloy.
   24. The method of any of clauses 22 and 23, wherein the article is a heat exchanger.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A brazing sheet comprising:
a substrate layer comprising an aluminum alloy;
an interliner layer disposed on the substrate layer, the interliner layer comprising an aluminum alloy comprising, in weight percentages,
0.05 to 1.0 magnesium,
0.5 to 5.0 zinc,
aluminum,
optionally incidental elements, and
impurities; and
a brazing layer comprising a 4XXX series aluminum alloy, the brazing layer disposed on the interliner layer;
provided that the interliner layer acts as a sacrificial anode and the substrate layer acts as a cathode of a galvanic circuit within the brazing sheet.

2. The brazing sheet of claim 1, wherein the interliner layer comprises, in weight percent, 1.5 to 3.0 zinc.

3. The brazing sheet of claim 1, wherein the interliner layer comprises, in weight percent, 2.0 to 5.0 zinc.

4. The brazing sheet of claim 1, wherein the interliner layer comprises, in weight percent, greater than 2.0 to 5.0 zinc.

5. The brazing sheet of claim 1, wherein a sum of the weight percentage concentrations of zinc and magnesium in the interliner layer is 2.0 to 6.0.

6. The brazing sheet of claim 1, wherein the interliner layer comprises an aluminum alloy comprising, in weight percentages:
0.1 to 1.0 silicon;
0 to 0.10 copper;
0 to 0.5 zirconium;
0 to 0.8 iron;
0 to 0.5 manganese;
2.0 to 5.0 zinc;
0.1 to 1.0 magnesium;
0 to 0.3 titanium;
0 to 0.05 chromium;
aluminum;
optionally incidental elements; and
impurities.

7. The brazing sheet of claim 1, wherein the interliner layer acts as a sacrificial anode of the galvanic circuit relative to the substrate layer and the brazing layer.

8. The brazing sheet of claim 1, wherein the substrate layer, the interliner layer, and the brazing layer are bonded together.

9. The brazing sheet of claim 1, wherein:
the brazing layer is a first brazing layer disposed on a first side of the substrate layer; and
a second brazing layer is disposed on a second side of the substrate layer, opposite the first side of the substrate layer, the second brazing layer comprising a 4XXX series aluminum alloy.

10. The brazing sheet of claim 9, wherein:
the interliner layer is a first interliner disposed intermediate the first brazing layer and the first side of the substrate layer; and
a second interliner layer is disposed intermediate the second brazing layer and the second side of the substrate layer.

11. The brazing sheet of claim 9, wherein the brazing sheet consists of the first brazing layer, the second brazing layer, the substrate layer, and the interliner layer.

12. The brazing sheet of claim 9, wherein the interliner layer comprises a thickness that is 8% to 30% of a total thickness of the brazing sheet.

13. The brazing sheet of claim 11, wherein the interliner layer comprises a thickness that is 15% to 30% of a total thickness of the brazing sheet.

14. The brazing sheet of claim 1, wherein the substrate layer comprises a 1XXX series aluminum alloy, a 3XXX series aluminum alloy, or a 6XXX series aluminum alloy.

15. (canceled)

16. The brazing sheet of claim 1, wherein the brazing layer is an aluminum alloy comprising, in weight percentages:
5 to 15.0 silicon;
0 to 2.5 magnesium;
0 to 1.0 iron;
0 to 1.5 zinc;
0 to 0.5 copper;
0 to 2.0 molybdenum;
0 to 0.3 manganese;
0 to 0.2 titanium;
0 to 0.4 bismuth;
0 to 0.01 chromium;
aluminum;
optionally incidental elements; and
impurities.

17. The brazing sheet of claim 1, wherein the substrate layer is an aluminum alloy comprising, in weight percentages:
0.1 to 1.0 silicon;
0 to 1.0 iron;
0 to 1.2 copper;
0.8 to 1.9 manganese;
0.05 to 1.2 magnesium;
0 to 0.10 chromium;
0 to 0.10 zinc;
aluminum;
optionally incidental elements; and
impurities; and
provided that a sum of the weight percentages of titanium and zirconium is 0.10 to 0.30.

18. The brazing sheet of claim 1, wherein the substrate layer is homogenized.

19. A heat exchanger comprising a structural element comprising all or a portion of the brazing sheet of claim 1.

20. (canceled)

21. The heat exchanger of claim 19, wherein the heat exchanger is corrosion resistant when subjected to at least 600 hours of continuous flow of an Oyama River water solution.

22. A method for forming an article, the method comprising:
contacting a first part comprising a first material with a second part comprising all or a portion of the brazing sheet of claim 1; and
coupling the first part to the second part by a process comprising at least one of controlled atmospheric brazing and vacuum brazing.

23. (canceled)

24. (canceled)
